(19) United States
(12) Patent Application Publication
(10) Pub. No.: US 2010/0012429 A1
(43) Pub. Date: Jan. 21, 2010

(54) Ladder Level

(76) Inventor: Wendell P. Bates, Thaxton, VA (US)

Correspondence Address: Kimberly A. Chasteen, PO Box 1243, Yorktown, VA, 23692, US

(21) Appl. No.: 12/506,230

(22) Filed: Jul. 20, 2009

Related U.S. Application Data
(60) Provisional application No. 61/135,157, filed on Jul. 18, 2008.

(51) Int. Cl. E06C 7/00

(52) U.S. Cl. 182/129

(57) ABSTRACT

A ladder level clamps to an extension ladder to place the ladder level in a horizontal plane and on a 15-degree angle to a vertical structure. The tool includes clamping handles and is secured to the ladder by spring pressure clamping with position stops. The tool also comprises a vial holder that serves as a position indicator. To indicate position, the vial holder includes two bubble vials. The clamping handles connected to the vial holder allowing for clamping and unclamping of the device.

### CROSS REFERENCE TO RELATED APPLICATION

The present application claims priority from U.S. Provisional Application Ser. No. 61/135,157, filed Jul. 18, 2008.

### BACKGROUND OF THE INVENTION

1. Field of the Invention

The present invention relates to a ladder level and more particularly to a clamping leveling tool that can be used to place an extension ladder in a level position in the horizontal plane and at a desired angle in the vertical plane.

2. Description of Related Art

Each year in the Unites States, the American Academy of Orthopedic Surgeons reports that more than 500,000 people are treated for ladder related injuries. This number does not include people who suffered injuries but did not go to a medical care provider for treatment.

One commonly used method for positioning a ladder is to place the lower edge of the ladder a distance away from the supporting structure a distance which is one fourth of the height at which the upper edge of the ladder comes into contact with the supporting structure. Obviously, this method is complex and requires difficult measuring to occur. Another method is to have a person stand with his toes touching the end of the ladder and then extend his arms horizontally towards the ladder. When the person's toes and hands touch the ladder simultaneously, it is presumed that the ladder is at a safe angle. This is not a very exact placement and depends on the size and shape of the person accomplishing the measurement.

One device developed for placing a ladder in a desired orientation is shown in Patent Application Number GB08037722. The leveling device for the published patent application can be used independently to level a ladder in the horizontal plane and the 15-degree angle (75 degrees from horizontal). The tool is hand held with the perpendicular side or the angle side press against a selected flat surface on the ladder to achieve the leveling requirement (horizontal or 15-degree angle). The disclosed invention is incapable of showing horizontal and vertical orientations at the same time. In use, it is first placed in one location to determine whether the ladder is level horizontally and in a second location to determine whether the ladder is at the correct angle in the vertical direction.

An object of the present invention is to provide a device for leveling a ladder.

An object of the present invention is to provide a device for leveling a ladder which provides for both horizontal and vertical placement of the ladder.

An object of the present invention is to provide a device for leveling a ladder which provides for simultaneous horizontal and vertical placement of the ladder.

A further object of the present invention is to provide a device for leveling a ladder which provides for vertical placement of the ladder at a 15 degree angle.

Yet another object of the present invention is to provide a device for leveling a ladder which can be used by a single person.

Finally, it is an object of the present invention to accomplish the foregoing objectives in a simple and cost effective manner.

### SUMMARY OF THE INVENTION

The present invention addresses these needs by providing a device for leveling a ladder. The device has first and second clamp elements, each having a proximal and a distal end. A biasing member, such as a torsion spring, biases the distal ends of the first and second clamp elements together. A holder element attached to either the first clamp element or the second clamp element includes a horizontal indicator indicating the horizontal orientation of the device and a vertical indicator indicating the vertical orientation of the device. The first and second clamp elements and the holder are constructed from a rigid material, such as plastic or a composite. The horizontal indicator may be a bubble vial, preferably with indicia to indicate when the bubble vial is in a horizontal orientation. The vertical indicator may be a bubble vial, also preferably with indicia to indicate when the bubble vial is in a vertical orientation which is about fifteen degrees from the vertical orientation of a vertical support structure.

### BRIEF DESCRIPTION OF THE DRAWINGS

A more complete description of the subject matter of the present invention and the advantages thereof, can be achieved by the reference to the following detailed description by which reference is made to the accompanying drawings in which:

FIG. 1 shows a front view of the ladder level according to the preferred embodiment of the present invention;

FIG. 2 shows a side view of the ladder level according to the preferred embodiment of the present invention;

FIG. 3a shows a front view of the S-clamp portion of the preferred embodiment of the present invention with the rear surface shown in dashed lines;

FIG. 3b shows a side view of the S-clamp portion of the preferred embodiment of the present invention with the internal surface shown in dashed lines;

FIG. 4a shows a front view of the M-clamp portion of the preferred embodiment of the present invention with the rear surface shown in dashed lines;

FIG. 4b shows a side view of the M-clamp portion of the preferred embodiment of the present invention with the internal surface shown in dashed lines;

FIG. 5a shows a top view of the vial holder portion of the preferred embodiment of the present invention with the lower surface shown in dashed lines;

FIG. 5b shows a side view of the vial holder portion of the preferred embodiment of the present invention with the internal surface shown in dashed lines;

FIG. 5c shows a front view of the vial holder portion of the preferred embodiment of the present invention with the internal surface shown in dashed lines;

FIG. 6 shows a front view of the ladder level according to the preferred embodiment of the present invention in use; and

FIG. 7 shows a side view of the ladder level according to the preferred embodiment of the present invention in use.

### ELEMENT LIST

10 ladder level

12 M-clamp

14 S-clamp

16 tension spring

18 pivot point

20 vial holder

22 horizontal indicator

24 vertical indicator

26 positioning surface

28 positioning surface

30 side of ladder

32 ladder step

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention.

The ladder level 10 is used for the purpose of leveling a ladder in a horizontal plane and placing it vertically at a 15 degree angle (75 degrees from horizontal). While the ladder level can be manufactured to show alternate vertical angles, the 15 degree angle is the angle that has been determined as preferable for placing a ladder on a vertical structure for safety purposes. If the ladder is too steep, i.e., if the angle between the ladder and the structure against which the ladder is leaning is less than 15 degrees then the ladder tends to pivot in a backward direction, falling away from the supporting structure and on the one using the ladder. Alternatively, if the angle is too great between the structure and the ladder, the feet of the ladder will slide outward and thus drop the person on the ladder to the ground. Many safety organizations and ladder manufacturers have adopted this standard and recommend that ladders be placed at 15 degrees from the structure supporting the ladder when in use.

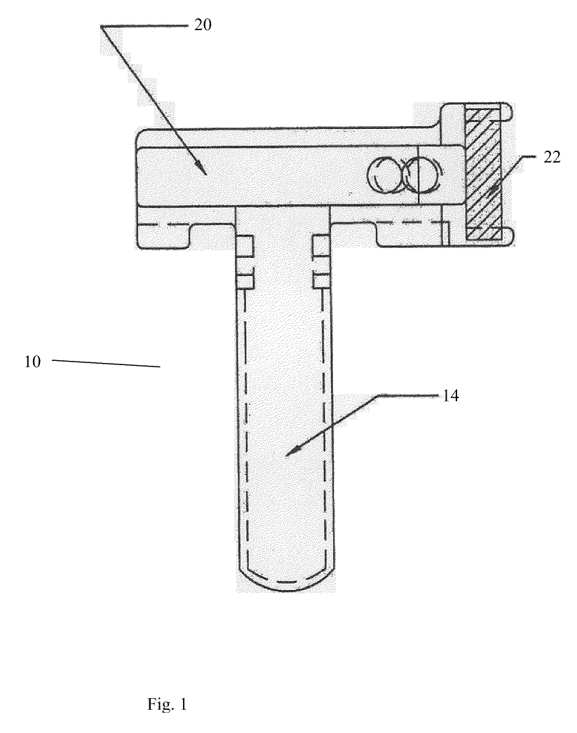

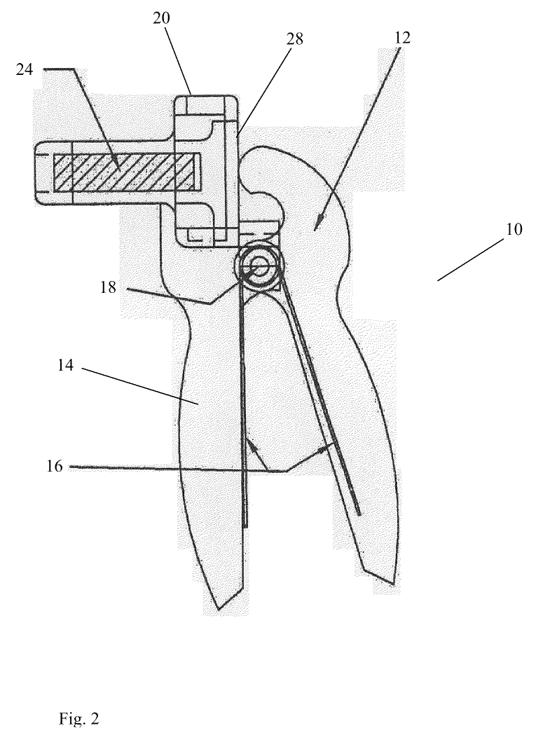

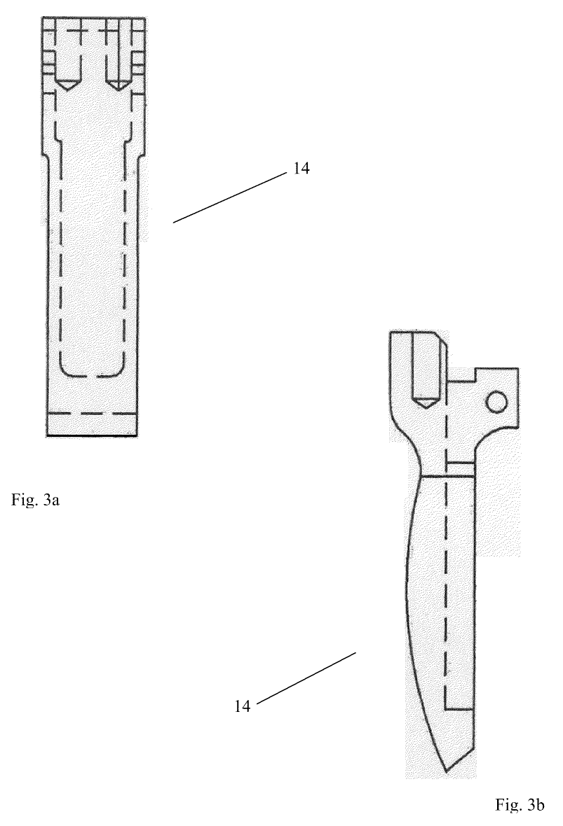

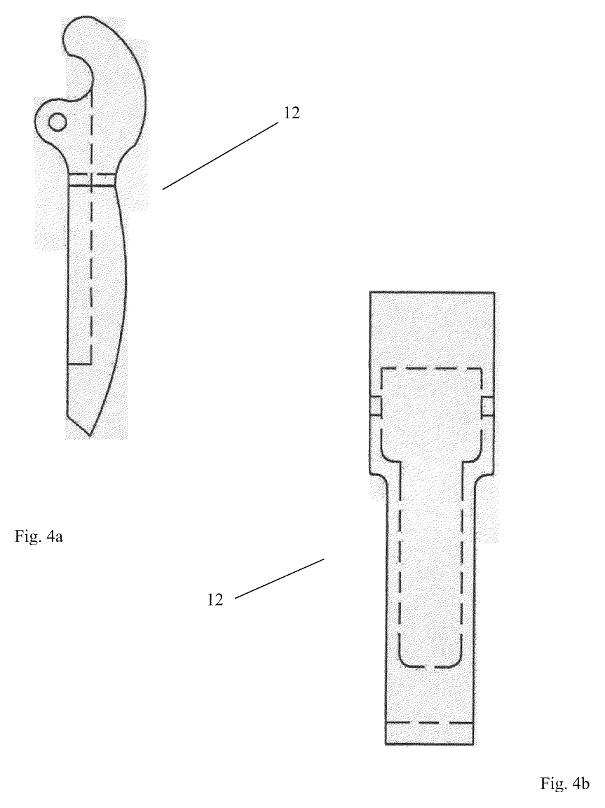

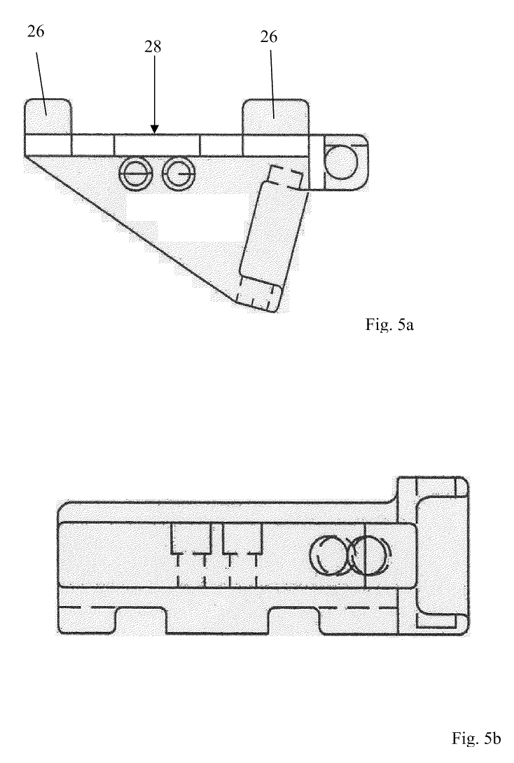

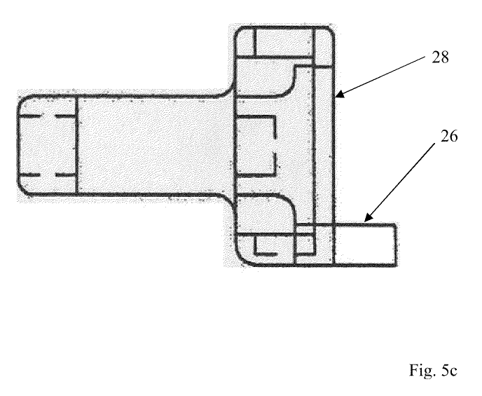

As shown in FIGS. 1 and 2, the ladder level consists of 3 parts preferably formed from a lightweight but rugged plastic material, one torsion spring, and assembly hardware. The first part, shown in more detail in FIGS. 4a and 4b is the M-Clamp 12. The M-Clamp 12 pivots open and close to secure the ladder level 10 to the ladder. The extent of the dimensional opening between the M-Clamp 12 and the S-Clamp 14 (see FIGS. 3a and 3b) is preferably approximately ⅜ inch. The S-Clamp 14 and the M-Clamp 12 preferably support a torsion spring 16 (see FIG. 2) for load pressure and which serves as a method for biasing the M-Clamp 12 and the S-Clamp 14 towards each other thus allowing the level to clamp the ladder level 10 to the ladder. The M-Clamp 12 pivots with the S-Clamp 14 from a pivot point formed by two screws and a threaded adapter. The third part of the ladder level 10 is the vial holder 20 which provides the information necessary for leveling and positioning a ladder. Two bubble vials 22,24 are positioned within the vial holder 20 at precise positions that are parallel to the horizontal plane (vial 22) and 15-degrees from vertical plane or 75 degrees from horizontal (vial 24). The vial holder 20 also has two positioning locators for clamping the level to the ladder. When clamped to a ladder, the ladder level 10 is moved towards the ladder until the ladder abuts the positioning surfaces 26. The positioning surface 28 then ensures that the ladder level 10 is flush against the ladder.

While described above as three elements, the device may be injection molded in alternate structures. For example, the vial holder 20 and the S-Clamp 14 may be molded together as a single part. Other alternate constructions are considered within the scope of the instant invention.

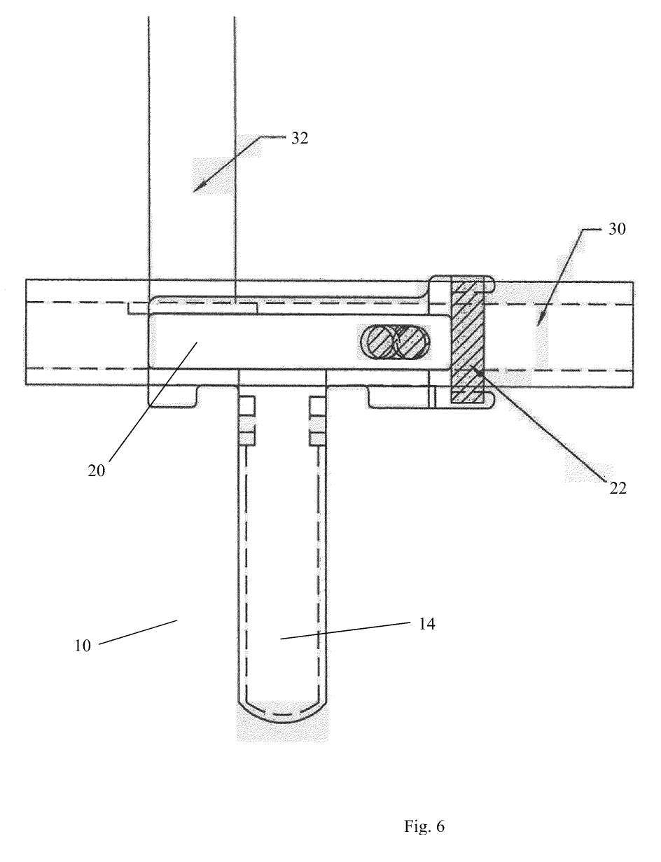

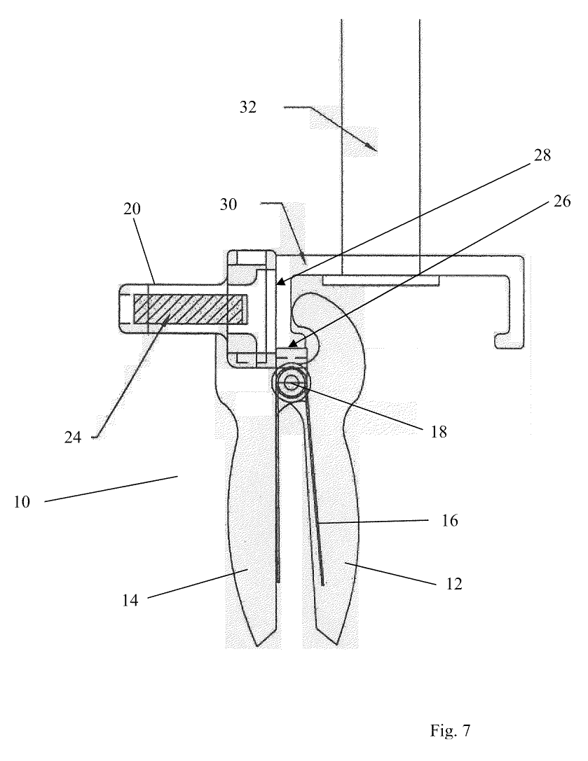

Use of the ladder level 10 is shown in FIGS. 6 and 7. The lower portions of the S-Clamp 14 and the M-Clamp 12 are forced together against the bias of the spring 16 causing an opening at the upper ends. The opening is placed on the side 30 of the ladder such that the ladder abuts against surfaces 26. The lower portions of the S-Clamp 14 and the M-Clamp 12 are then released allowing the spring 16 to return to its biased position thus attaching the ladder level 10 to the ladder. The ladder is then arranged such that the horizontal vial 22 indicates that the ladder is level in the horizontal direction and such that the vertical vial 24 indicates that the ladder is at an angle of 15 degrees from the structure supporting the ladder. The ladder level 10 is a tool that will take the guesswork out of placing an extension ladder at the correct angle. The ladder level 10 easily attaches to any fiber glass or aluminum ladder. The tool can be unclamped from the ladder or can remain on the ladder.

Obviously, many modifications may be made without departing from the basic spirit of the present invention. Accordingly, it will be appreciated by those skilled in the art that within the scope of the appended claims, the inventions may be practiced other than has been specifically described herein. Many improvements, modifications, and additions will be apparent to the skilled artisan without departing from the spirit and scope of the present invention as described herein and defined in the following claims.

What is claimed is:

1. A ladder leveling device for horizontally and vertically orienting a ladder, comprising:
a first clamp element having a proximal and a distal end;
a second clamp element, having a proximal and a distal end, pivotally attached to the first clamp element;
a biasing member biasing the distal ends of the first and second clamp elements together; and
a holder element attached to either the first clamp element or the second clamp element, the holder element, comprising:
a horizontal indicator indicating the horizontal orientation of the device; and
a vertical indicator indicating the vertical orientation of the device.

2. The device as set forth in claim 1 wherein the first and second clamp elements and the holder are constructed from a rigid material.

3. The device as set forth in claim 1 wherein first and second clamp elements and the holder are constructed from a material selected from the group consisting of plastic and composites.

4. The device as set forth in claim 1 wherein the biasing member is a spring.

5. The device as set forth in claim 1 wherein the biasing member is a torsion spring biasing the proximal ends of the first and second clamp elements apart such that the distal ends are biased together in a clamping orientation.

6. The device as set forth in claim 1 wherein the horizontal indicator is a bubble vial.

7. The device as set forth in claim 6 wherein the bubble vial includes indicia to indicate when the bubble vial is in a horizontal orientation.

8. The device as set forth in claim 1 wherein the vertical indicator is a bubble vial.

9. The device as set forth in claim 8 wherein the bubble vial includes indicia to indicate when the bubble vial is in a vertical orientation which is about fifteen degrees from the vertical orientation of a vertical support structure.
